(19) United States
(12) Patent Application Publication
(10) Pub. No.: US 2013/0321494 A1
(43) Pub. Date: Dec. 5, 2013

(54) LIQUID CRYSTAL DISPLAY

(71) Applicant: MITSUBISHI ELECTRIC CORPORATION, TOKYO (JP)

(72) Inventor: Jiro TAKAKI, Tokyo (JP)

(73) Assignee: MITSUBISHI ELECTRIC CORPORATION, TOKYO (JP)

(21) Appl. No.: 13/900,456

(22) Filed: May 22, 2013

(30) Foreign Application Priority Data
Jun. 4, 2012 (JP) 2012-127201

(51) Int. Cl. G09G 3/36; G09G 3/20

(52) U.S. Cl. CPC G09G 3/3685; G09G 3/2018
USPC 345/691; 345/89

(57) ABSTRACT

A liquid crystal panel includes a pixel electrode, a common electrode, a plurality of data lines, a plurality of pixel selection lines, and a pixel switching unit. A driving device includes a data line driving unit, a pixel selection line driving unit, a voltage generation unit for generating various voltages used for the data line driving unit, the pixel selection line driving unit, and the common electrode, and a control unit. The control unit has an input discrimination unit for discriminating between an input state where a video signal is inputted and a non-input state where the video signal is not inputted, and a regulation unit for regulating a potential difference between the pixel electrode and the common electrode to zero with respect to the plurality of pixels in the non-input state.

### BACKGROUND OF THE INVENTION

1. Field of the Invention

The present invention relates to a technique for preventing image persistence or the like of a liquid crystal panel.

2. Description of the Background Art

In a liquid crystal display, a voltage is applied to a liquid crystal layer to change an orientation of liquid crystal, and with this orientation control, the transmittance of light is controlled. In other words, by controlling an applied voltage, an expression of gradation can be achieved.

The liquid crystal display is, generally, driven by an alternating current in order to avoid a problem in display such as image persistence. The image persistence is a phenomenon in which a desired voltage is not applied to the liquid crystal layer even when a display screen is changed and consequently a display content of the previous screen faintly remains. It is thought that the image persistence is caused by concentration of ion components in the liquid crystal layer on an electrode as a DC voltage (DC bias) continues to be applied to the liquid crystal layer.

The DC bias can also cause a flicker. In an IPS (In-Plane-Switching) system for wide viewing angle and an FFS (Fringe Field Switching) system which is a kind of the IPS system, for example, when a DC bias is applied, the pixels absorb DC bias components because of its pixel structure. For this reason, even if a normal AC driving is started after that, a flicker occurs due to an offset by the residual DC bias components for a while.

Japanese Patent Application Laid Open Gazette No. 6-27902, WO 2009/011150, and Japanese Patent Application Laid Open Gazette No. 2010-72393 disclose examples of the related art.

In a conventional liquid crystal display, the DC bias is applied to the liquid crystal layer in a period from the power-on to the time when a video signal is actually inputted. In other words, in a conventional start-up sequence, the power-on timing and the input timing of the video signal are defined but no measures for preventing application of the DC bias in the period between these timings are taken.

For this reason, in a case where it takes a long time from the power-on to the input of the video signal (for example, a case where a user does not follow a specified start-up sequence), the DC bias is applied to the liquid crystal layer for a long time and this may cause some problems in display such as image persistence, flicker, and the like. Further, in the FFS system, when the DC bias is applied to the liquid crystal layer before the video signal is inputted (in other words, before the AC driving is started), it takes a considerable time until the residual components are extinguished and a flicker is recognized in the meantime.

Though the period from the power-on to the input of the video signal is taken as an example, also in a case, for example, where the input of the video signal is stopped during a display operation or a case where no subsequent video signal is inputted after the display operation is finished, the DC bias is applied to the liquid crystal layer. In summary, in the conventional liquid crystal display, the DC bias may be applied to the liquid crystal layer even in a state where no video signal is inputted.

### SUMMARY OF THE INVENTION

It is an object of the present invention to provide a liquid crystal display capable of preventing a DC bias from being applied to a liquid crystal layer in a state where no video signal is inputted.

The present invention is intended for a liquid crystal display. According to an aspect of the present invention, the liquid crystal display includes a liquid crystal panel and a driving device for driving the liquid crystal panel. The liquid crystal panel includes a plurality of pixel electrodes provided with respect to a plurality of pixels respectively, a common electrode for supplying the plurality of pixels with a common voltage, a plurality of data lines, a plurality of pixel selection lines, and a plurality of pixel switching units provided with respect to the plurality of pixels respectively. Each of the plurality of the pixel switching units has one end connected to a corresponding pixel electrode, the other end connected to a predetermined data line, and a control end connected to a predetermined pixel selection line, for controlling conduction between the one end and the other end. The driving device includes a data line driving unit for driving the plurality of data lines, a pixel selection line driving unit for driving the plurality of pixel selection lines to control the plurality of pixel switching units, a voltage generation unit for generating various voltages used for the data line driving unit, the pixel selection line driving unit, and the common electrode, and a control unit for controlling an operation of the driving device. The control unit has an input discrimination unit for discriminating between an input state where a video signal is inputted, and a non-input state where the video signal is not inputted and a regulation unit for regulating a potential difference between the pixel electrode and the common electrode to zero with respect to the plurality of pixels in the non-input state.

According to the above aspect, a potential difference between the pixel electrode and the common electrode is regulated to zero with respect to all the pixels in the non-input state. Therefore, in the non-input state, it is possible to prevent a DC bias from being applied to a liquid crystal layer. As a result, problems in display, such as image persistence, flicker, and the like, can be avoided.

These and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a block diagram showing a liquid crystal display in accordance with a first preferred embodiment;

FIG. 2 is a plan view showing a liquid crystal panel in accordance with the first preferred embodiment;

FIG. 3 is a circuit diagram showing pixels in the liquid crystal panel in accordance with the first preferred embodiment;

FIG. 4 is a view showing a synchronization unit in accordance with the first preferred embodiment;

FIG. 5 is a block diagram showing a regulation unit in accordance with the first preferred embodiment;

FIGS. 6 to 8 are circuit diagrams each showing a gradation voltage regulation unit in accordance with the first preferred embodiment;

FIG. 9 is a view showing a data output control unit (source output control unit) in accordance with the first preferred embodiment;

FIG. 10 is a view showing a pixel switching control unit (gate output control unit) in accordance with the first preferred embodiment;

FIGS. 11 to 13 are circuit diagrams each showing a common voltage regulation unit in accordance with the first preferred embodiment;

FIG. 14 is a view showing an operation sequence of the liquid crystal display in accordance with the first preferred embodiment;

FIG. 15 is a view showing a conventional operation sequence for comparison with FIG. 14;

FIG. 16 is a block diagram showing a regulation unit in accordance with a second preferred embodiment;

FIGS. 17 and 18 are circuit diagrams each showing a pixel switching control unit (gate-OFF voltage control unit) in accordance with the second preferred embodiment;

FIG. 19 is a block diagram showing a regulation unit in accordance with a third preferred embodiment;

FIGS. 20 and 21 are circuit diagrams each showing a gradation voltage regulation unit in accordance with the third preferred embodiment;

FIG. 22 is a block diagram showing a liquid crystal display in accordance with a fourth preferred embodiment;

FIG. 23 is a view showing an input discrimination unit in accordance with a fifth preferred embodiment; and

FIG. 24 is a view showing a pixel switching control unit (gate output control unit) in accordance with a sixth preferred embodiment.

### DESCRIPTION OF THE PREFERRED EMBODIMENTS

### The First Preferred Embodiment

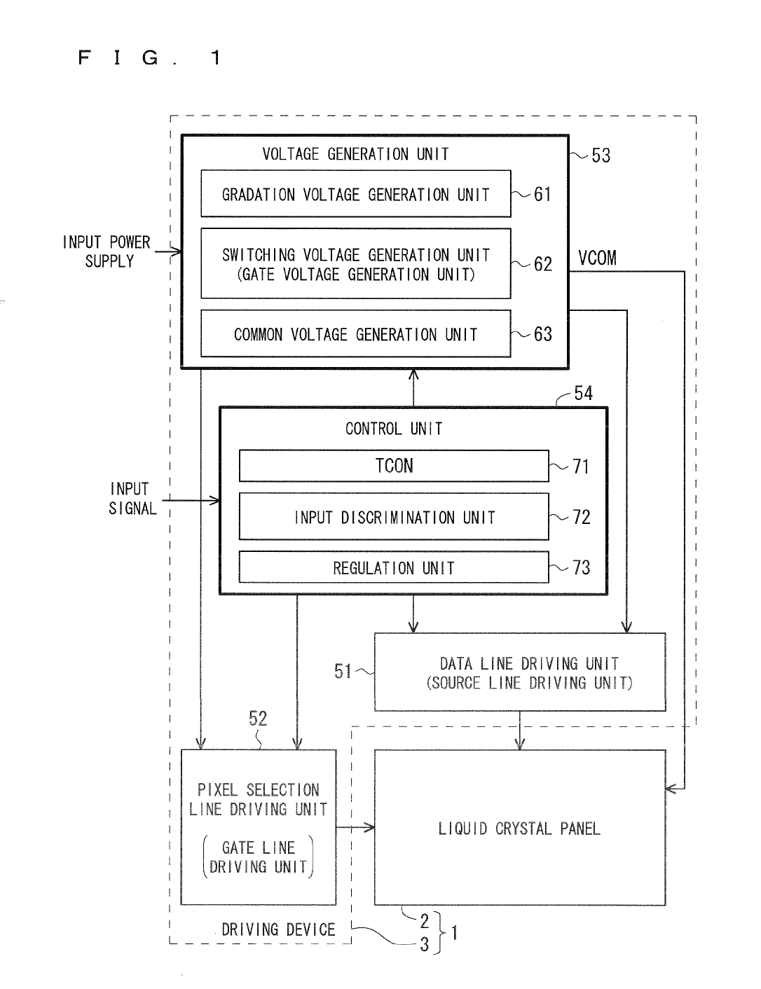

FIG. 1 is a block diagram showing a liquid crystal display 1 in accordance with the first preferred embodiment. In the exemplary constitution of FIG. 1, the liquid crystal display 1 includes a liquid crystal panel 2 and a driving device 3 for driving the liquid crystal panel 2. The liquid crystal panel 2 may be a full-color display type or a single-color display type (not limited to black and white). Further, the liquid crystal panel 2 may be a transmission type, a reflection type, or a semi-transmission type. In a case where the liquid crystal panel 2 is a transmission type or a semi-transmission type, a structure further including a backlight device may be referred to as the liquid crystal display 1.

<Liquid Crystal Panel 2>

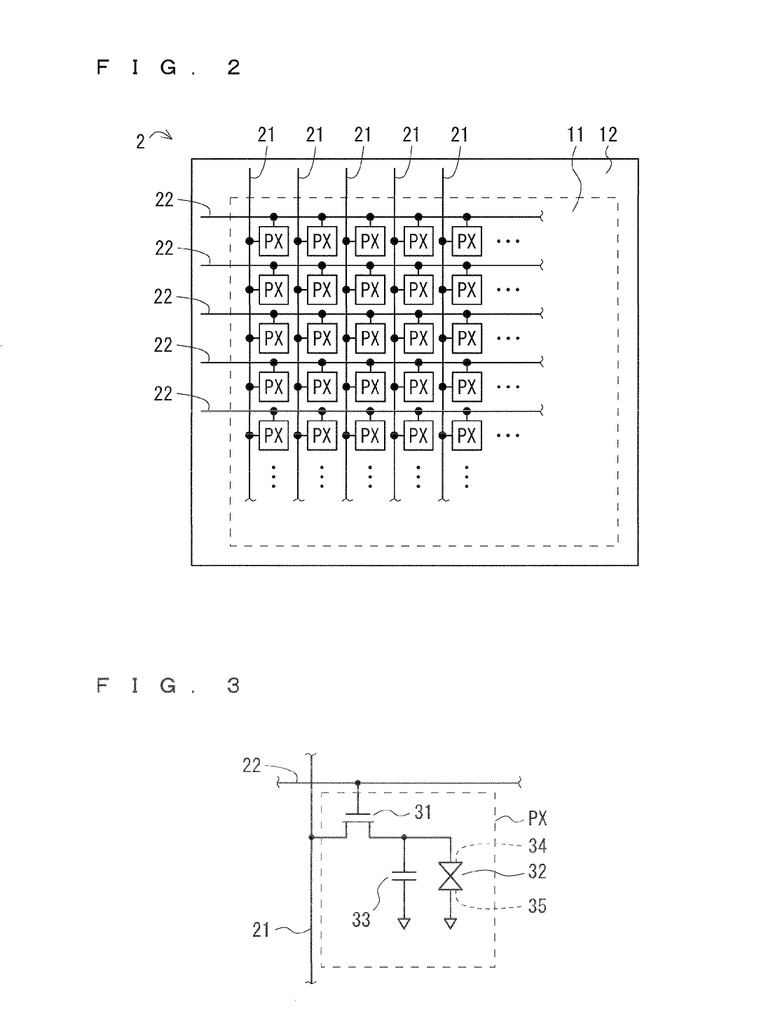

FIG. 2 is a plan view schematically showing the liquid crystal panel 2. As shown in FIG. 2, the liquid crystal panel 2 is broadly divided into a pixel arrangement area 11 and a surrounding area 12 surrounding the pixel arrangement area 11. The surrounding area is also referred to as a frame area. Respective shapes, sizes, and the like of the liquid crystal panel 2, the pixel arrangement area 11, and the surrounding area 12 are not limited to those shown in FIG. 2.

The liquid crystal panel 2 has a plurality of pixels PX, a plurality of data lines 21, and a plurality of pixel selection lines 22. As shown in FIG. 2, each of the pixels PX is connected to a predetermined one of the plurality of data lines 21 and a predetermined one of the plurality of pixel selection lines 22.

The pixels PX are dispersed planarly in the pixel arrangement area 11, to constitute a display screen on which an image (including characters or the like) is displayed. In the exemplary arrangement of FIG. 2, the pixels PX are aligned in both a row direction (horizontal direction in FIG. 2) and a column direction (vertical direction in FIG. 2) in the pixel arrangement area 11. In other words, the plurality of pixels PX are arranged in a matrix. Further, the plurality of pixels PX may be arranged, for example, in a delta formation.

The data line 21 is a line for supplying a pixel PX with a voltage (gradation voltage) having a voltage value in accordance with display data (more specifically, gradation data) of the pixel PX. In the exemplary arrangement of FIG. 2, each data line 21 extends in the column direction and the plurality of data lines 21 are arranged in the row direction.

The pixel selection line 22 is a line for selecting a pixel PX to be supplied with the gradation voltage. The selection of the pixel PX is achieved by sequentially selecting the plurality of pixel selection lines 22, in other words, by scanning the plurality of pixel selection lines 22. In the exemplary arrangement of FIG. 2, each pixel selection line 22 extends in the row direction and the plurality of pixel selection lines 22 are arranged in the column direction.

As discussed above, each pixel PX is connected to one of the plurality of data lines 21 and one of the plurality of pixel selection lines 22. Therefore, to each data line 21, connected are a plurality of pixels PX (some of all the pixels PX) which are connected to different pixel selection lines 22. Further, to each pixel selection line 22, connected are a plurality of pixels PX (some of all the pixels PX) which are connected to different data lines 21. In this case, a combination of a data line 21 and a pixel selection line 22 can specify a pixel PX.

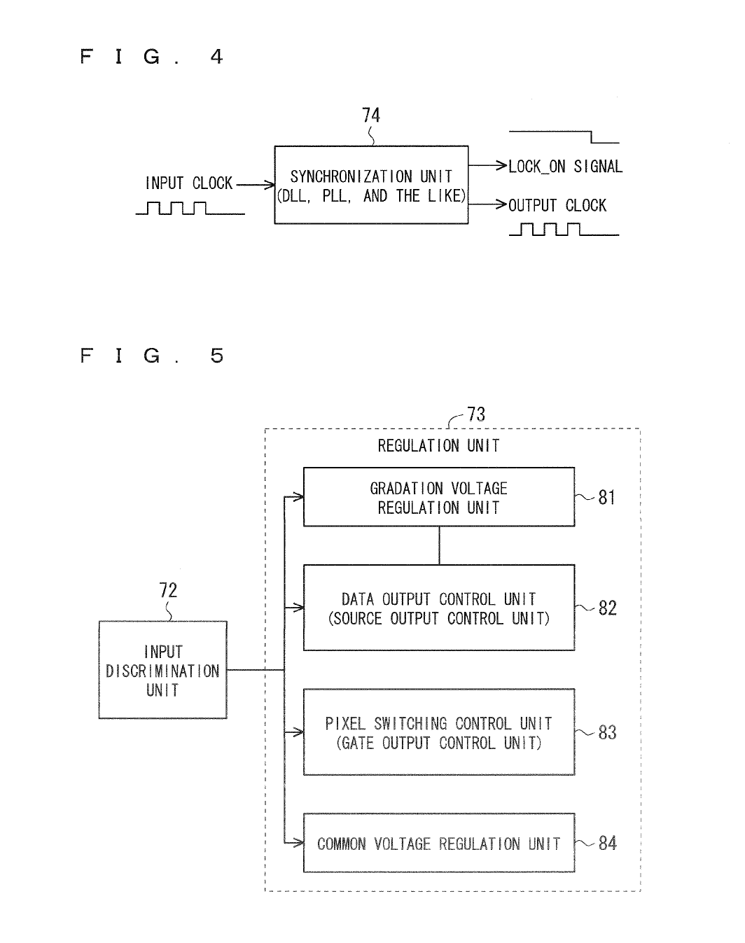

FIG. 3 is a circuit diagram schematically showing the pixel PX. The pixel PX shown in FIG. 3 has a pixel switching unit 31, a basic cell 32, and a storage capacity 33.

The pixel switching unit 31 is formed of a TFT (Thin Film Transistor) herein. For this reason, hereinafter, the pixel switching unit 31 is also referred to as a TFT 31, a pixel TFT 31, or the like. In the case of the TFT 31, by controlling a gate voltage, conduction between a source and a drain can be controlled. Further, the pixel switching unit 31 may be formed of another switching element or the like.

A gate (in other words, a control end) of the pixel TFT 31 is connected to a predetermined pixel selection line 22, a source of the pixel TFT 31 is connected to the data line 21, and a drain of the pixel TFT 31 is connected to the basic cell 32. In consideration of this connection, hereinafter, the data line 21 is also sometimes referred to as a source line 21, and the pixel selection line 22 is also sometimes referred to as a gate line 22.

The basic cell 32 is a structure serving as a base unit of the pixel PX and includes a pixel electrode 34, a common electrode 35, and a liquid crystal layer. The pixel electrode 34 is provided for each pixel PX and connected to the drain of the TFT 31 of the pixel PX. The common electrode 35 is an electrode for supplying each of all the pixels PX with a common voltage.

In a TN (Twisted Nematic) mode or the like, for example, the pixel electrode 34 and the common electrode 35 are provided on different substrates with the liquid crystal layer interposed therebetween. On the other hand, in an IPS (In Plane Switching) mode, an FFS (Fringe Field Switching) mode, or the like, for example, the pixel electrode 34 and the common electrode 35 are provided on the same substrate.

One electrode of the storage capacity 33 is connected to the drain of the pixel TFT 31. The other electrode of the storage capacity 33 is connected to a predetermined potential, e.g., a common potential to be applied to the common electrode 35. Further, a pixel structure which has no storage capacity 33 may be adopted. The storage capacity is also referred to as an auxiliary capacitance.

In the case of the pixel PX having the above structure, when the gate of the pixel TFT 31 is brought into an ON state by applying a voltage to the gate line 22, the voltage of the source line 21 at that time (the gradation voltage corresponding to the display data) is supplied to the pixel electrode 34. At that time, the orientation of liquid crystal molecules is changed by an electric field caused between the pixel electrode 34 and the common electrode 35, and display luminance of the pixel PX is thereby changed. The potential of the pixel electrode 34 is retained by the storage capacity 33.

<Driving Device 3>

With reference back to FIG. 1, the driving device 3 includes a data line driving unit 51, a pixel selection line driving unit 52, a voltage generation unit 53, and a control unit 54.

The data line driving unit 51 is connected to the data lines 21 of the liquid crystal panel 2, for example, through FPC (Flexible Printed Circuits), to drive the data lines 21. Specifically, the data line driving unit 51 controls the potential of each data line 21, and this controls the potential of each pixel electrode 34. Further, as the data line 21 is also referred to as the source line 21, hereinafter, the data line driving unit 51 is also sometimes referred to as a source line driving unit 51.

The source line driving unit 51 can be formed of one or more source driver ICs (Integrated Circuits). Though an exemplary case is taken herein, where a general-type source driver IC is adopted, the source line driving unit 51 is not limited to this case.

The pixel selection line driving unit 52 is connected to the pixel selection lines 22 of the liquid crystal panel 2, for example, through the FPC, to drive the pixel selection lines 22. Specifically, the pixel selection line driving unit 52 controls the potential of each pixel selection line 22, and this controls the gate voltage of each pixel TFT 31 and controls conduction of each pixel TFT 31. Further, as the pixel selection line 22 is also referred to as the gate line 22, hereinafter, the pixel selection line driving unit 52 is also sometimes referred to as a gate line driving unit 52.

The gate line driving unit 52 can be formed of one or more gate driver ICs. Though an exemplary case is taken herein, where a general-type gate driver IC is adopted, the gate line driving unit 52 is not limited to this case.

The voltage generation unit 53 generates various voltages used for the source line driving unit 51, the gate line driving unit 52, and the common electrode 35 from an input power supply and supplies the generated voltages to the source line driving unit 51, the gate line driving unit 52, and the common electrode 35, respectively. The voltage generation unit 53 can be formed of a so-called DC/DC converter circuit.

The voltage to be supplied to the source line driving unit 51 includes, for example, a logic voltage used for the source driver IC, and the gradation voltage to be supplied to the pixel electrode 34 through the source line driving unit 51. The voltage to be supplied to the gate line driving unit 52 includes, for example, a logic voltage used for the gate driver IC, and the gate voltage to be supplied to the pixel TFT 31 through the gate line driving unit 52. The voltage to be supplied to the common electrode 35 includes, for example, a common voltage VCOM.

In FIG. 1, as constituent elements of the voltage generation unit 53, a gradation voltage generation unit 61, a switching voltage generation unit 62, and a common voltage generation unit 63 are shown as an example. The gradation voltage generation unit 61 generates a plurality of gradation voltages corresponding to a plurality of gradation levels. All the generated gradation voltages are supplied to the source line driving unit 51.

The switching voltage generation unit 62 generates a switching-ON voltage for bringing the pixel TFT 31 into an ON state and a switching-OFF voltage for bringing the pixel TFT 31 into an OFF state. Further, the switching voltage generation unit 62 is also sometimes referred to as a gate voltage generation unit 62, the switching-ON voltage is also sometimes referred to as a gate-ON voltage, and the switching-OFF voltage is also sometimes referred to as a gate-OFF voltage. The generated switching-ON voltage and switching-OFF voltage are supplied to the gate line driving unit 52.

The common voltage generation unit 63 generates the common voltage VCOM, and the generated common voltage VCOM is supplied to the common electrode 35.

<Control Unit 54>

The control unit 54 controls an operation of the driving device 3. Specifically, in a state (hereinafter, referred to also as an “input state”) where a video signal is inputted to an input unit (for example, an external connection terminal) for the video signal, the control unit 54 controls the driving device 3 so that the liquid crystal panel 2 should perform a display operation in accordance with the video signal. On the other hand, in a state (hereinafter, referred to also as a “non-input state”) where no video signal is inputted to the input unit, the control unit 54 performs a control discussed later so that a DC voltage (DC bias) should not be applied to the liquid crystal layer.

It is assumed herein that the video signal includes the display data and a control reference signal. The control reference signal includes, for example, a horizontal synchronizing signal served as a reference signal used for establishing synchronization in the horizontal direction of the liquid crystal panel, a vertical synchronizing signal served as a reference signal used for establishing synchronization in the vertical direction of the liquid crystal panel, a data enable signal indicating a period in which the display data is valid, a synchronization reference clock signal which is used by a supply destination (herein, the control unit 54) to establish synchronization with the video signal in the supply of the video signal, and the like.

Signal components such as the display data and the like are inputted to the control unit 54, being, for example, superposed on one signal. In this case, the various components are used, being separated in the control unit 54. Alternatively, the signal components such as the display data and the like may be inputted to the control unit 54, being separated.

As a display operation in the input state, herein, a general display operation will be shown as an example. Specifically, a timing controller (hereinafter, referred to also as a “TCON”) 71 provided in the control unit 54 controls the source line driving unit 51 and the gate line driving unit 52 on the basis of the video signal.

Specifically, the gate line driving unit 52 has a scan function for sequentially selecting the plurality of gate lines 22 and supplying the gate-ON voltage to the selected gate line 22, and the scan function is controlled by the TCON 71.

In other words, the TCON 71 inputs a scan start instruction to the gate line driving unit 52 in synchronization with the vertical synchronizing signal included in the video signal. The scan start instruction is achieved by setting a so-called gate start pulse signal to be active. In the gate line driving unit 52, the gate start pulse signal is passed on sequentially to gate line driving circuits assigned to the gate lines 22, respectively, in accordance with a scan clock signal (a so-called gate clock signal), to thereby provide an application timing of the gate-ON voltage.

Thus, when the gate start pulse signal becomes active, the gate line driving unit 52 supplies the switching-ON voltage to a first gate line 22 set in advance and sequentially changes the gate line 22 to be supplied with the switching-ON voltage in accordance with the gate clock signal. Further, by setting the gate start pulse signal to be active in a predetermined cycle, the sequential scanning of the gate lines 22 is repeated.

The TCON 71 acquires display data (gradation data) of each of the pixels PX belonging to the selected gate line 22 from the video signal and sends the display data to the source line driving unit 51. The source line driving unit 51 supplies each of the source lines 21 with a gradation voltage in accordance with the gradation data of the corresponding pixel PX.

At that time, the TCON 71 gives a voltage application timing from the source line driving unit 51 to the source line 21 with a control signal referred to as a latch pulse. When the latch pulse is in a Low level, for example, an output buffer of the source line driving unit 51 is brought into an enable state (output state), and when the latch pulse is in a High level, for example, the output buffer of the source line driving unit 51 is brought into a Hi-Zo state (high-impedance state).

In order to achieve an operation in the non-input state, the control unit 54 includes an input discrimination unit 72 for discriminating between the input state and the non-input state and a regulation unit 73 operating in accordance with a discrimination result of the input discrimination unit 72.

<Input Discrimination Unit 72>

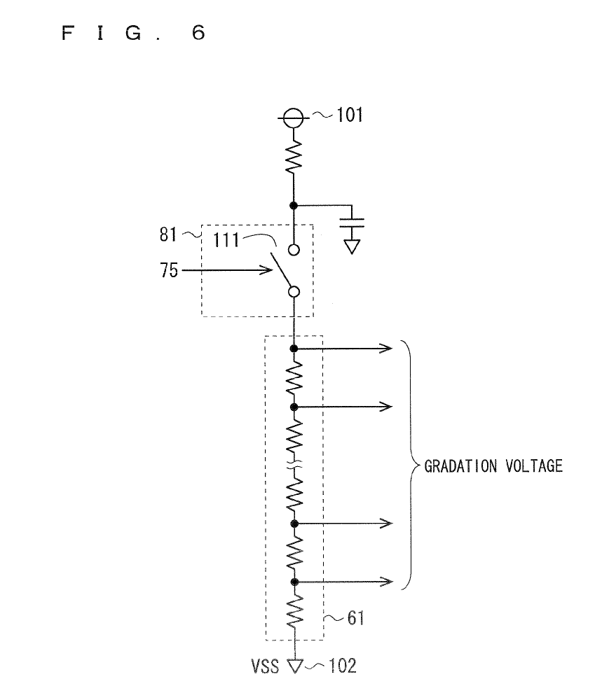

The input discrimination unit 72 can be implemented, for example, by using a synchronization unit 74 (see FIG. 4) incorporated in the TCON 71. Specifically, the synchronization unit 74 is a circuit unit used for establishing synchronization with an input signal inputted to the input unit for the video signal and formed of a DLL (Delay Locked Loop), a PLL (Phase Locked Loop), and the like. According to the DLL and the PLL, in a state where an input clock (which corresponds to the synchronization reference clock signal included in the video signal) is stably inputted, the DLL and the PLL are brought into a LOCK_ON state to output a LOCK_ON signal (see FIG. 4).

In consideration of this, the input discrimination unit 72 determines that the liquid crystal display 1 is in the input state when a condition (synchronization condition) that synchronization with the input signal is established is satisfied, and more specifically when the synchronization unit 74 is in the LOCK_ON state. Further, the input discrimination unit 72 may be integrated with the TCON 71 as an IC.

<Regulation Unit 73>

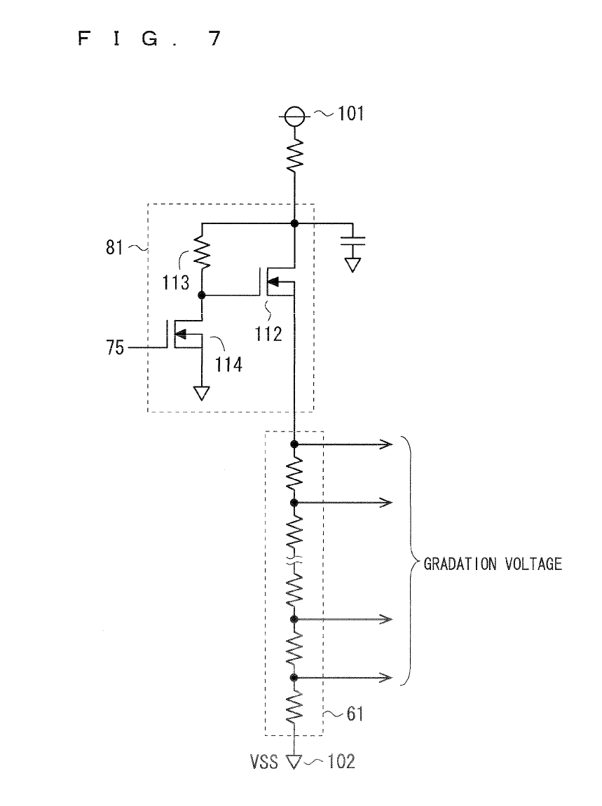

In the non-input state, the regulation unit 73 regulates a potential difference between the pixel electrode 34 and the common electrode 35 to zero with respect to each pixel PX. FIG. 5 is a block diagram showing the regulation unit 73. In the exemplary constitution of FIG. 5, the regulation unit 73 includes a gradation voltage regulation unit 81, a data output control unit 82, a pixel switching control unit 83, and a common voltage regulation unit 84. Hereinafter, the data output control unit 82 is also sometimes referred to as a source output control unit 82 and the pixel switching control unit 83 is also sometimes referred to as a gate output control unit 83.

<Gradation Voltage Regulation Unit 81>

In the non-input state, the gradation voltage regulation unit 81 changes all the plurality of gradation voltages outputted from the gradation voltage generation unit 61 to a predetermined regulated potential. On the other hand, in the input state, the gradation voltage regulation unit 81 controls the gradation voltage generation unit 61 to output the plurality of gradation voltages without any change.

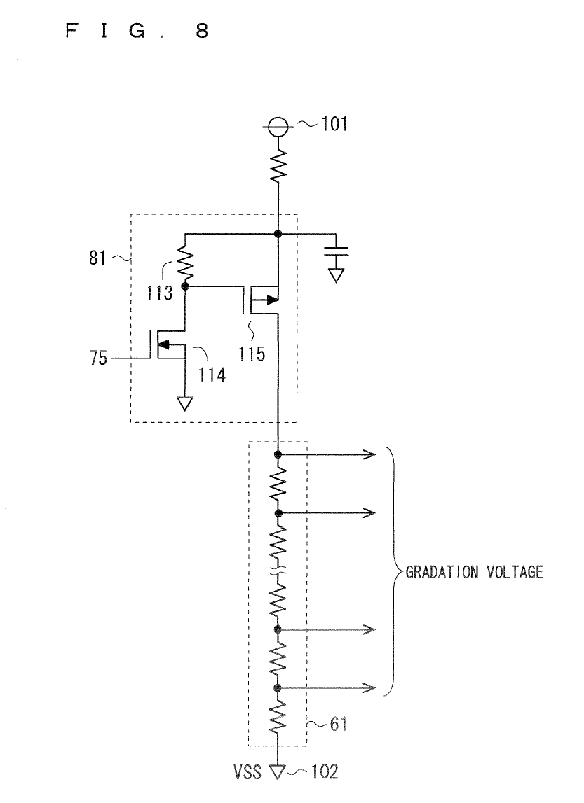

FIG. 6 is a circuit diagram showing the gradation voltage regulation unit 81. FIG. 6 also shows an exemplary circuit of the gradation voltage generation unit 61, and the gradation voltage generation unit 61 shown in FIG. 6 is formed of a so-called ladder resistor circuit. The ladder resistor circuit is provided between a high power supply potential 101 (specifically, an analog power supply for driving a circuit) and a low power supply potential 102 (specifically, a ground potential VSS). The configuration of the gradation voltage generation unit 61, however, is not limited to the exemplary configuration show in FIG. 6.

In the exemplary configuration of FIG. 6, the gradation voltage regulation unit 81 is formed of a switch 111 provided between the gradation voltage generation unit 61 and the high power supply potential 101. The open/close of the switch 111 is controlled in accordance with an input discrimination result signal 75, in other words, in accordance with whether the input state or the non-input state.

In the exemplary configuration of FIG. 6, the switch 111 is controlled to become a close state in the input state, and a plurality of gradation voltages having different voltage levels are thereby outputted from the gradation voltage generation unit 61. On the other hand, in the non-input state, the switch 111 is controlled to become an open state, and all the gradation voltages are thereby brought into the potential VSS. In other words, all the gradation voltages are regulated to the potential VSS and this potential VSS corresponds to the above-discussed regulated potential.

FIGS. 7 and 8 show more specific exemplary configurations of the gradation voltage regulation unit 81. The configuration of the gradation voltage regulation unit 81, however, is not limited to these examples.

In the exemplary configuration of FIG. 7, a source of an N-channel MOS transistor 112 is connected to the gradation voltage generation unit 61, and a drain of the MOS transistor 112 is connected to the high power supply potential 101 through a resistor. A gate of the MOS transistor 112 is connected to the drain of the MOS transistor 112 through a resistor 113 and connected to a drain of an N-channel MOS transistor 114. A source of the MOS transistor 114 is grounded. The input discrimination result signal 75 is inputted to a gate of the MOS transistor 114.

In the exemplary configuration of FIG. 8, the N-channel MOS transistor 112 of FIG. 7 is replaced by a P-channel MOS transistor 115.

<Data Output Control Unit 82>

In the non-input state, the data output control unit (source output control unit) 82 controls the data line driving unit (source line driving unit) 51 so that the regulated potential VSS outputted from the gradation voltage generation unit 61 should be supplied to all the data lines (source lines) 21.

On the other hand, in the input state, the data output control unit 82 controls the data line driving unit 51 to perform a normal operation. Specifically, with the normal operation of the data line driving unit 51, the voltage to be applied to each data line 21 is selected out of the plurality of gradation voltages supplied from the gradation voltage generation unit 61 on the basis of the corresponding gradation data. Then, the selected gradation voltage is applied to the data line 21. Further, with respect to all the data lines 21, the application of the gradation voltages is performed at the same time at a predetermined timing (indicated by the latch pulse).

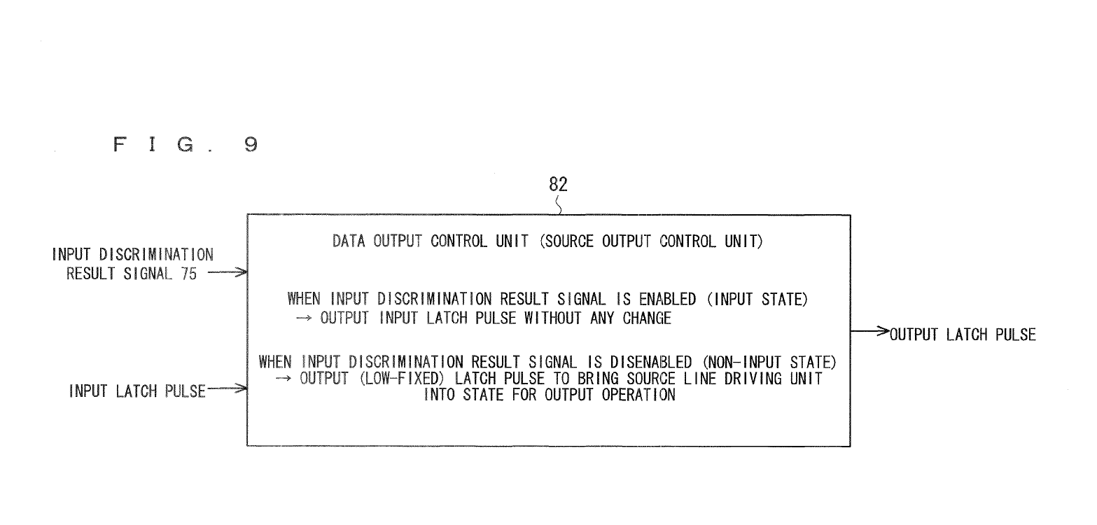

FIG. 9 illustrates a logical structure of the source output control unit 82. In the exemplary structure of FIG. 9, when the input discrimination result signal 75 indicates the input state, the source output control unit 82 outputs an input latch pulse generated by the TCON 71, without any change, to the source line driving unit 51 as an output latch pulse. The source line driving unit 51 thereby performs the above-discussed normal operation.

On the other hand, when the input discrimination result signal 75 indicates the non-input state, the source output control unit 82 outputs the output latch pulse fixed to a Low level to the source line driving unit 51. In the non-input state, the TCON 71 does not generate any latch pulse. For this reason, the source output control unit 82 spontaneously outputs the output latch pulse (fixed to the Low level), and the source line driving unit 51 can thereby apply the regulated potential VSS to the source lines 21.

Further, the source output control unit 82 may be integrated with the TCON 71 as an IC.

<Pixel Switching Control Unit 83>

In the non-input state, the pixel switching control unit (gate output control unit) 83 controls the pixel selection line driving unit (gate line driving unit) 52 so that the pixel TFT 31 of each of all the pixels PX should not be brought into the OFF state (the pixel TFT 31 of each of all the pixels PX should be brought into the ON state in the first preferred embodiment).

Specifically, the pixel selection line driving unit 52 has an ALL_ON function, and the pixel switching control unit 83 activates the ALL_ON function in the non-input state. The ALL_ON function refers to a function for enabling all the output buffers in the pixel selection line driving unit 52 at the same time to bring into a state for output operation. With this ALL_ON function, the switching-ON voltage can be applied to all the pixel selection lines (gate lines) 22 at the same time, and all the pixel TFTs 31 can be brought into the ON state at the same time.

By using the ALL_ON function which is incorporated in advance in the pixel selection line driving unit 52, it is possible to simplify the constitution of the pixel switching control unit 83 and reduce the cost.

On the other hand, in the input state, the pixel switching control unit 83 controls the pixel selection line driving unit 52 to perform a normal operation, i.e., the above scanning operation. Specifically, the pixel switching control unit 83 inactivates the above-discussed ALL_ON function.

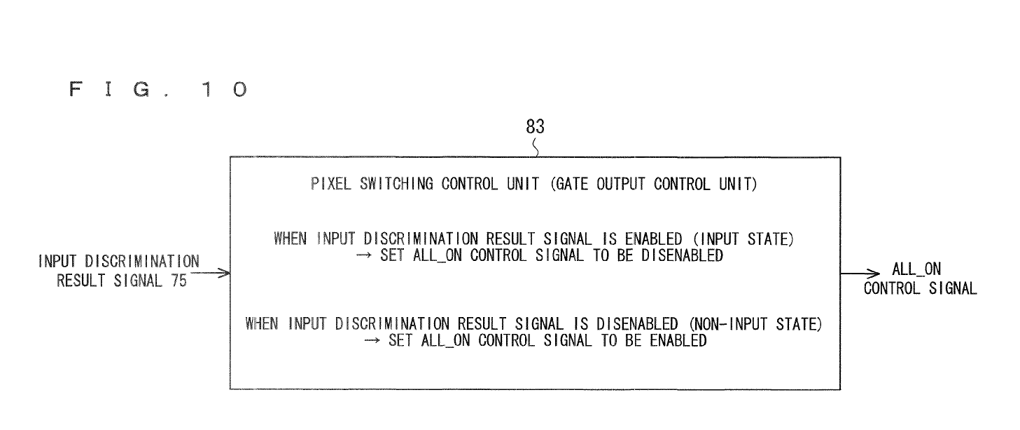

FIG. 10 illustrates a logical structure of the gate output control unit 83. In the exemplary structure of FIG. 10, when the input discrimination result signal 75 indicates the input state, the gate output control unit 83 sets an ALL_ON control signal to be disenabled. This inactivates the ALL_ON function. On the other hand, when the input discrimination result signal 75 indicates the non-input state, the gate output control unit 83 sets the ALL_ON control signal to be enabled. This activates the ALL_ON function.

Further, the gate output control unit 83 may be integrated with the TCON 71 as an IC.

<Common Voltage Regulation Unit 84>

In the non-input state, the common voltage regulation unit 84 changes the common voltage VCOM to the above-discussed regulated potential VSS. On the other hand, in the input state, the common voltage regulation unit 84 controls the common voltage generation unit 63 to output the common voltage VCOM having a predetermined potential.

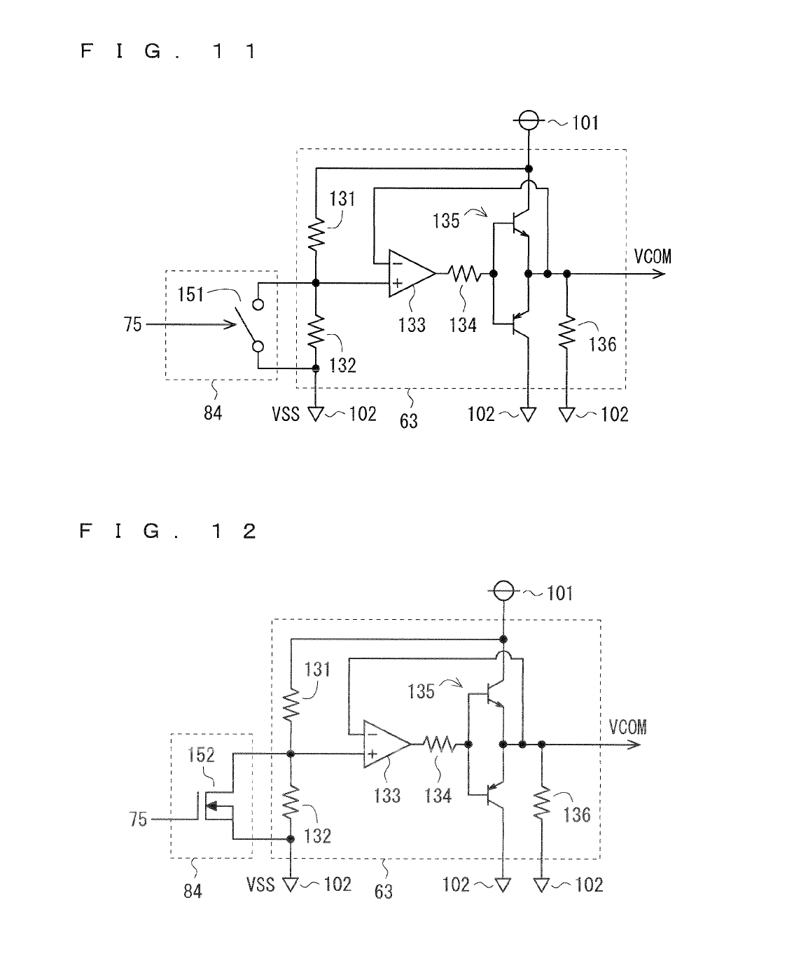

FIG. 11 is a circuit diagram showing the common voltage regulation unit 84. FIG. 11 also shows an exemplary circuit of the common voltage generation unit 63. In the exemplary configuration of FIG. 11, the common voltage generation unit 63 is provided between the high power supply potential 101 (specifically, the analog power supply for driving a circuit) and the low power supply potential 102 (specifically, the ground potential VSS).

More specifically, between the potentials 101 and 102, resistors 131 and 132 are connected in series, and a connection point of the resistors 131 and 132 is connected to a positive input end of an operational amplifier 133, to thereby provide a reference potential to be used for generating the common voltage. To a negative input end of the operational amplifier 133, the common voltage VCOM which is an output voltage is fed back. An output end of the operational amplifier 133 is connected to one end of a resistor 136 through a resistor 134 and a current amplification circuit 135 (formed of a complementary transistor in the exemplary configuration of FIG. 11). The other end of the resistor 136 is connected to the low power supply potential 102, and the potential at the above one end of the resistor 136 is outputted as the common voltage VCOM. The configuration of the common voltage generation unit 63, however, is not limited to the example shown in FIG. 11.

In the exemplary configuration of FIG. 11, the common voltage regulation unit 84 is formed of a switch 151 provided between the positive input end of the operational amplifier 133 (to which the reference potential used for generating the common voltage is inputted as discussed above) and the low power supply potential 102. The open/close of the switch 151 is controlled in accordance with the input discrimination result signal 75, in other words, in accordance with whether the input state or the non-input state.

In the exemplary configuration of FIG. 11, the switch 151 is controlled to become an open state in the input state. A potential obtained by dividing the voltage between the potentials 101 and 102 by the resistors 131 and 132 is thereby inputted to the operational amplifier 133, and the common voltage VCOM having a designed voltage value is outputted. On the other hand, in the non-input state, the switch 151 is controlled to become a close state. The low power supply potential 102 (the ground potential VSS) is thereby inputted to the operational amplifier 133, and the common voltage VCOM consequently becomes the potential VSS. In other words, the common voltage VCOM is regulated to the potential VSS.

FIGS. 12 and 13 show more specific exemplary configurations of the common voltage regulation unit 84. The configuration of the common voltage regulation unit 84, however, is not limited to these examples.

In the exemplary configuration of FIG. 12, the switch 151 is formed of an N-channel MOS transistor 152 connected in parallel to the resistor 132 on the low potential side. The input discrimination result signal 75 is inputted to a gate of the MOS transistor 152.

In the exemplary configuration of FIG. 13, the gate of the MOS transistor 152 is connected to a drain of an N-channel MOS transistor 153, and the drain of the MOS transistor 153 is connected to the logic voltage 103 through a resistor 154. A source of the MOS transistor 153 is connected to the low power supply potential 102, and the input discrimination result signal 75 is inputted to a gate of the MOS transistor 153.

<Operation in Non-Input State>

In the above-discussed configuration, in the non-input state, the potential VSS is applied to all the pixel electrodes 34 and also applied to the common electrode 35, and therefore the potential difference between the pixel electrode 34 and the common electrode 35 becomes zero with respect to each of all the pixels PX. It is thereby possible to prevent the DC bias from being applied to the liquid crystal layer in the non-input state. As a result, it is possible to prevent any problem in display such as image persistence, flicker, or the like.

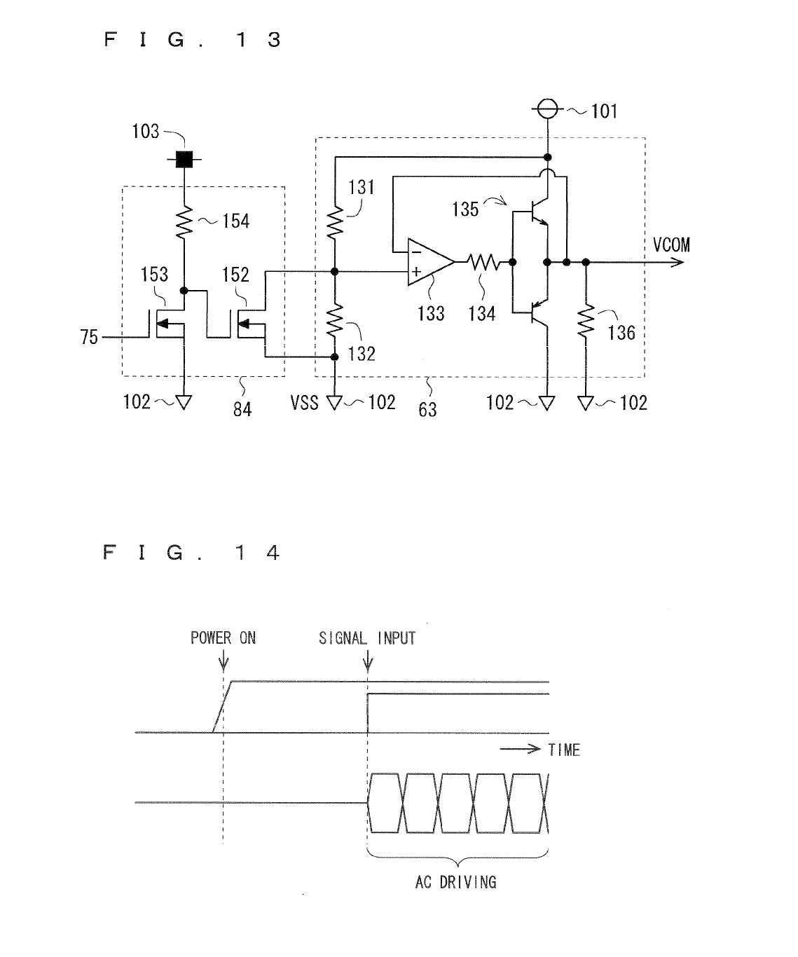

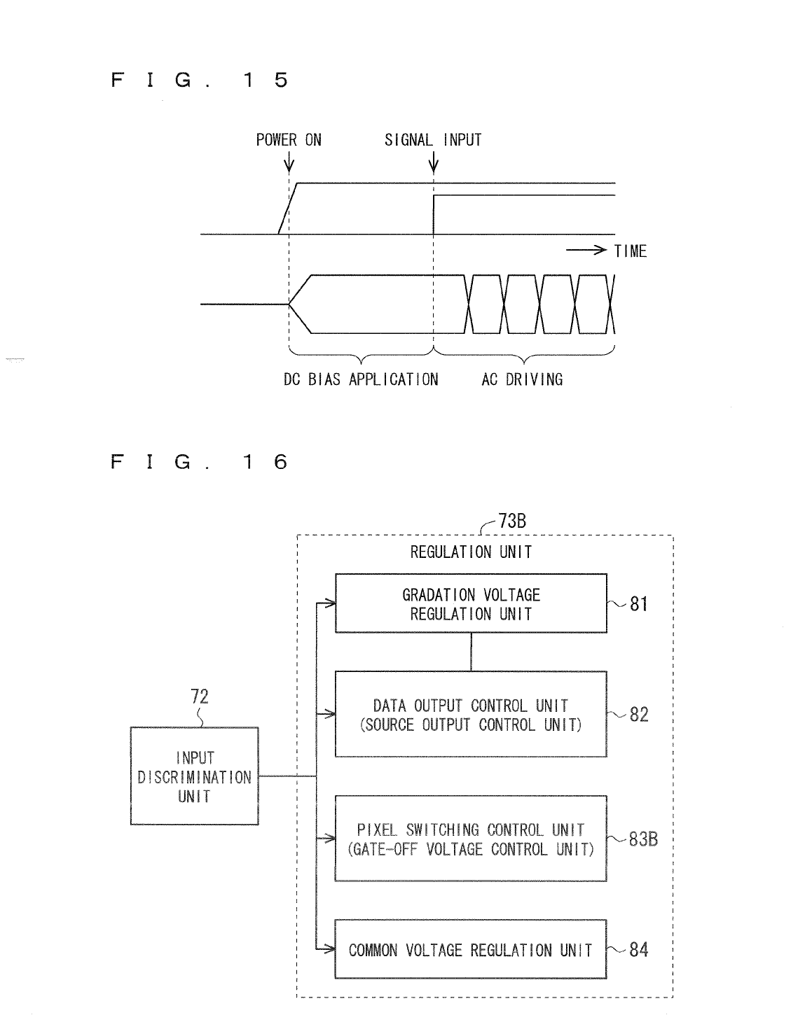

Regarding the above-discussed effect, FIG. 14 illustrates an operation sequence of the liquid crystal display 1 in accordance with the first preferred embodiment, and FIG. 15 illustrates an operation sequence of a convention liquid crystal display for comparison. In the exemplary cases of FIGS. 14 and 15, there is a non-input state in a period between the power-on to the input of the video signal. It can be seen from the comparison between FIGS. 14 and 15, in the period, the application of the DC bias is prevented in the liquid crystal display 1 in accordance with the first preferred embodiment.

Herein, it is thought that various uses are made in a general-purpose display device. When a use not following a start-up sequence is made, as shown in FIG. 15, the DC bias may be applied. In the liquid crystal display 1 in accordance with the first preferred embodiment, however, it is possible to prevent the application of the DC bias even when such a use is made (see FIG. 14).

Though discussion has been made on the operation at the start-up of the display device with reference to FIGS. 14 and 15, there is a case where the device is brought into the non-input state, for example, when the input signal is stopped for some reason during a normal operation. Even in such a case, the liquid crystal display 1 performs the above-discussed regulating operation, to thereby produce the above-discussed effect.

Further, the liquid crystal display 1 does not stop the voltage generation unit 53 even in the non-input state. For this reason, a normal display operation can be started, quickly following the transition from the non-input state to the input state.

### The Second Preferred Embodiment

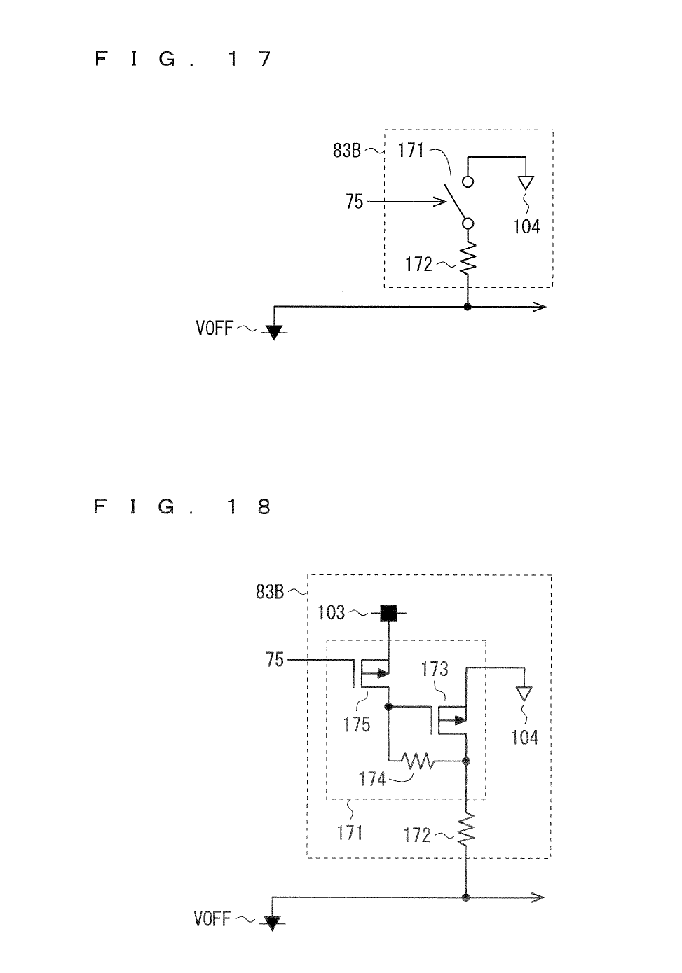

FIG. 16 is a block diagram showing a regulation unit 73B in accordance with the second preferred embodiment. The regulation unit 73B, instead of the regulation unit 73 of the first preferred embodiment, is adopted in the liquid crystal display 1 (see FIG. 1). In the exemplary constitution of FIG. 16, the regulation unit 73B includes the gradation voltage regulation unit 81, the data output control unit 82 (in other words, the source output control unit 82), and the common voltage regulation unit 84 shown in the first preferred embodiment and also includes a pixel switching control unit 83B in accordance with the second preferred embodiment.

In the non-input state, the pixel switching control unit 83B changes the switching-OFF voltage (the gate-OFF voltage) applied to the pixel TFT 31 through the gate line 22 to a potential with which the pixel TFT 31 should not actually be brought into the OFF state. In consideration of this, hereinafter, the pixel switching control unit 83B is also sometimes referred to as a switching-OFF voltage control unit 83B, a gate-OFF voltage control unit 83B, or the like.

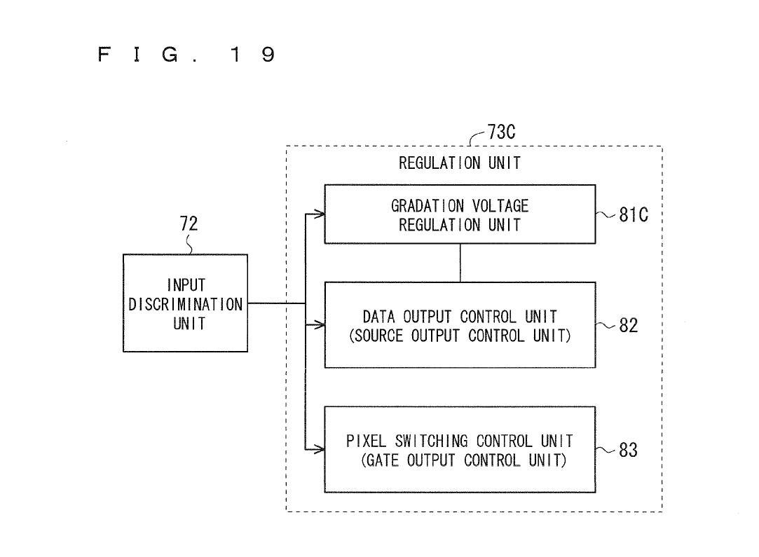

FIG. 17 is a circuit diagram showing the gate-OFF voltage control unit 83B. In the exemplary configuration of FIG. 17, the gate-OFF voltage control unit 83B is provided with respect to a transmission line of the gate-OFF voltage VOFF from the gate voltage generation unit 62 (see FIG. 1) to the gate line driving unit 52 (see FIG. 1). More specifically, the gate-OFF voltage control unit 83B is formed of a switch 171 and a resistor 172 connected in series between the transmission line and a predetermined power supply potential 104. The open/close of the switch 171 is controlled in accordance with the input discrimination result signal 75, in other words, in accordance with whether the input state or the non-input state.

In the exemplary configuration of FIG. 17, in the input state, the switch 171 is controlled to become an open state, and the gate-OFF voltage VOFF thereby has a designed voltage value. On the other hand, in the non-input state, the switch 171 is controlled to become a close state, and the gate-OFF voltage VOFF thereby becomes higher than the designed voltage value.

Particularly, the high value of the gate-OFF voltage after the change is selected to be a value with which the pixel TFT 31 should not be brought into the OFF state (more specifically, a value with which the pixel TFT 31 should be brought into a complete ON state or with which the pixel TFT 31 may not be brought into the complete ON state but should be brought into a conducting state where a current (in other words, electric charges) can flow between the source and the drain thereof).

FIG. 18 illustrates a more specific exemplary configuration of the switch 171. The configuration of the switch 171, however, is not limited to this example. In the exemplary configuration of FIG. 18, a P-channel MOS transistor 173 is connected between the power supply potential 104 and the resistor 172. A gate of the MOS transistor 173 is connected to a drain thereof through a resistor 174 and also connected to the logic voltage 103 through another P-channel MOS transistor 175. The input discrimination result signal 75 is inputted to a gate of the MOS transistor 175.

Further, in the non-input state, a voltage level of the gate-OFF voltage is controlled by the resistor 172 so as to fall within a specification range of the gate driver IC.

In the above-discussed configuration, in the non-input state, the potential of the gate-OFF voltage VOFF is changed as discussed above, and even when the changed gate-OFF voltage VOFF is applied, the pixel TFT 31 is not brought into a complete OFF state. Therefore, in association with the operations of the gradation voltage regulation unit 81 and the source output control unit 82, the regulated potential VSS is applied to all the pixel electrodes 34. Further, even if there is a pixel PX to which the gate-ON voltage is applied, the regulated potential VSS is still applied to all the pixel electrodes 34.

Further, like in the first preferred embodiment, with the operation of the common voltage regulation unit 84, the potential VSS is also applied to the common electrode 35.

Therefore, in the non-input state, the potential difference between the pixel electrode 34 and the common electrode 35 becomes zero with respect to each of all the pixels PX. Like in the first preferred embodiment, it is thereby possible to prevent the DC bias from being applied to the liquid crystal layer in the non-input state, and as a result, it is possible to prevent any problem in display such as image persistence, flicker, or the like.

Particularly in the second preferred embodiment, the gate line driving unit 52 do not have to have the ALL_ON function. For this reason, the second preferred embodiment is more versatile.

Further, like in the first preferred embodiment, the liquid crystal display 1 does not stop the voltage generation unit 53 even in the non-input state. For this reason, a normal display operation can be started, quickly following the transition from the non-input state to the input state.

### The Third Preferred Embodiment

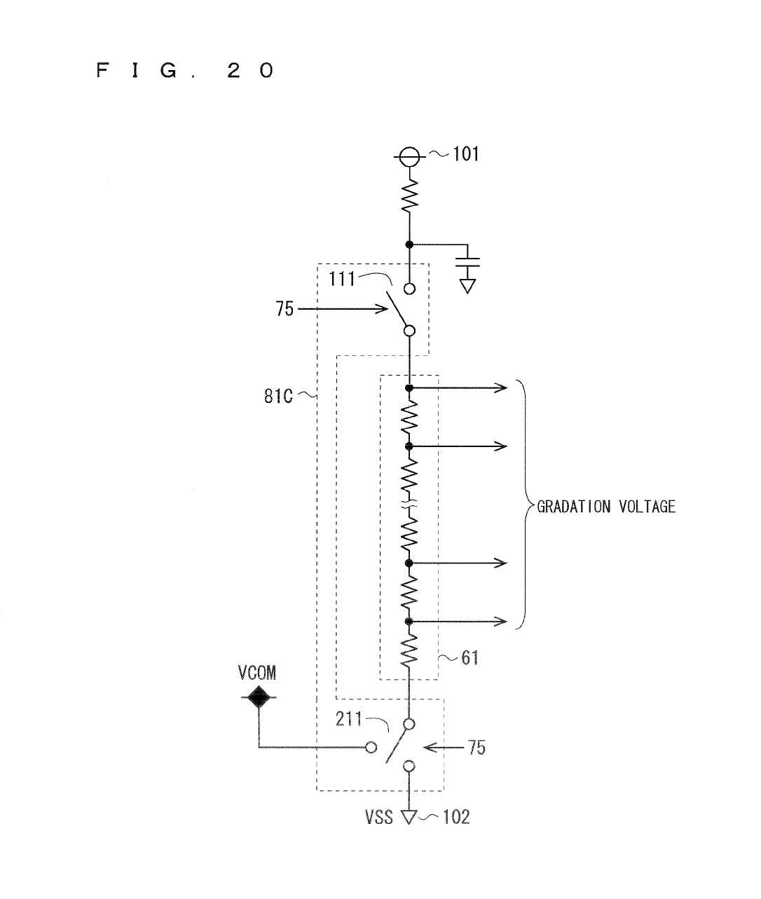

FIG. 19 is a block diagram showing a regulation unit 73C in accordance with the third preferred embodiment. The regulation unit 73C, instead of the regulation unit 73 of the first preferred embodiment, is adopted in the liquid crystal display 1 (see FIG. 1). In the exemplary constitution of FIG. 19, the regulation unit 73 C includes the data output control unit 82 (in other words, the source output control unit 82) and the pixel switching control unit 83 (in other words, the gate output control unit 83) shown in the first preferred embodiment and also includes a gradation voltage regulation unit 81C in accordance with the third preferred embodiment.

In the non-input state, the gradation voltage regulation unit 81C changes all the plurality of gradation voltages outputted from the gradation voltage generation unit 61 to the common voltage VCOM. On the other hand, in the input state, the gradation voltage regulation unit 81C controls the gradation voltage generation unit 61 to output the plurality of gradation voltages without any change.

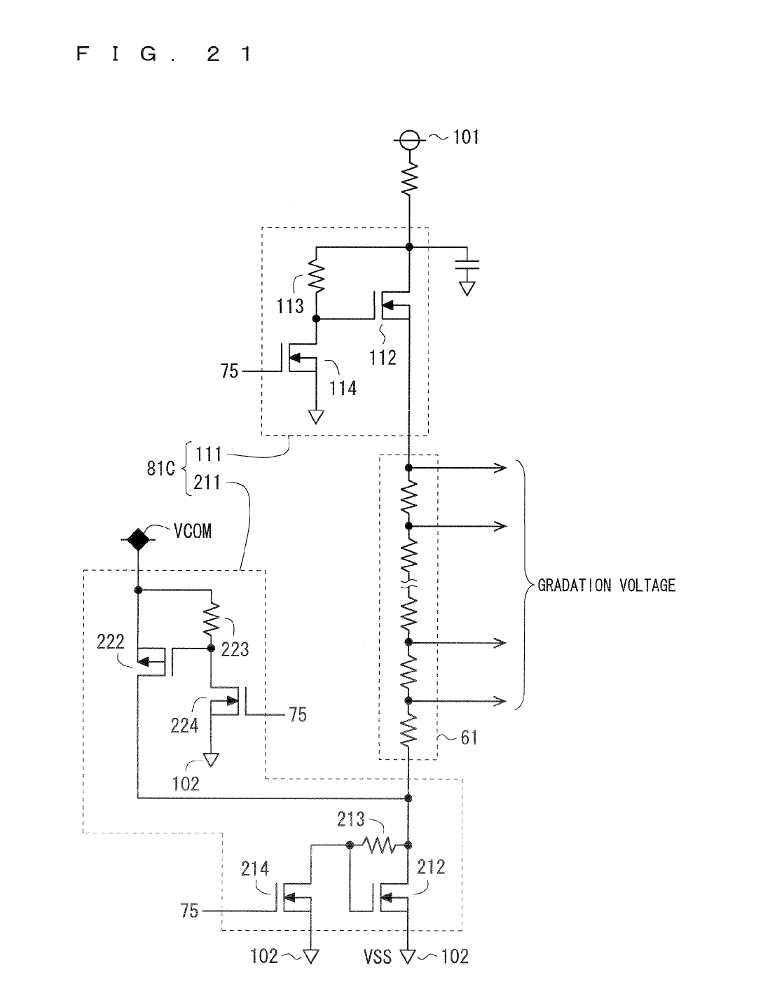

FIG. 20 is a circuit diagram showing the gradation voltage regulation unit 81C. FIG. 20 also shows the same ladder resistor circuit as that in the first preferred embodiment as an exemplary circuit of the gradation voltage generation unit 61.

In the exemplary configuration of FIG. 20, the gradation voltage regulation unit 81C is formed of switches 111 and 211. The switch 111 is provided between the high potential end of the ladder resistor circuit and the high power supply potential 101, like in the first preferred embodiment. The switch 211 is a so-called selector switch and so provided as to connect the low potential end of the ladder resistor circuit to the low power supply potential 102 or the common voltage VCOM. The open/close of the switch 111 and the connection selection of the switch 211 are controlled in accordance with the input discrimination result signal 75, in other words, in accordance with whether the input state or the non-input state.

In the exemplary configuration of FIG. 20, in the input state, the switch 111 is controlled to become a close state and the switch 211 is connected to the low power supply potential 102. A plurality of gradation voltages having different voltage levels are thereby outputted from the gradation voltage generation unit 61. On the other hand, in the non-input state, the switch 111 is controlled to become an open state and the switch 211 is connected to the common voltage VCOM. All the gradation voltages are thereby regulated to the common voltage VCOM.

FIG. 21 illustrates a more specific exemplary configuration of the gradation voltage regulation unit 81C. The configuration of the gradation voltage regulation unit 81C, however, is not limited to this example. In the exemplary configuration of FIG. 21, the switch 111 has the same configuration as that of the switching circuit shown in FIG. 7 (the constituent of the gradation voltage regulation unit 81 in the first preferred embodiment).

The switch 211 is also formed by applying the switching circuit thereto. Specifically, a drain of an N-channel MOS transistor 212 is connected to a low potential end of the ladder resistor circuit and a source of the MOS transistor 212 is connected to the low power supply potential 102. A gate of the MOS transistor 212 is connected to the drain thereof through a resistor 213 and also connected to a drain of an N-channel MOS transistor 214. A source of the MOS transistor 214 is grounded. The input discrimination result signal 75 is inputted to a gate of the MOS transistor 214. A drain of a P-channel MOS transistor 222 is connected to the low potential end of the ladder resistor circuit and a source of the MOS transistor 222 is connected to the common voltage VCOM. A gate of the MOS transistor 222 is connected to the source thereof through a resistor 223 and also connected to a drain of an N-channel MOS transistor 224. A source of the MOS transistor 224 is grounded. The input discrimination result signal 75 is inputted to a gate of the MOS transistor 224.

In the above-discussed configuration, in the non-input state, the common voltage

VCOM is applied to all the pixel electrodes 34 and also applied to the common electrode 35, and therefore the potential difference between the pixel electrode 34 and the common electrode 35 becomes zero with respect to each of all the pixels PX. Like in the first preferred embodiment, it is thereby possible to prevent the DC bias from being applied to the liquid crystal layer in the non-input state, and as a result, it is possible to prevent any problem in display such as image persistence, flicker, or the like.

Particularly in the third preferred embodiment, the potential of the common electrode 35 does not have to be controlled. For this reason, it is possible to simplify the constitution and reduce the cost.

Further, like in the first preferred embodiment, the liquid crystal display 1 does not stop the voltage generation unit 53 even in the non-input state. For this reason, a normal display operation can be started, quickly following the transition from the non-input state to the input state.

### The Fourth Preferred Embodiment

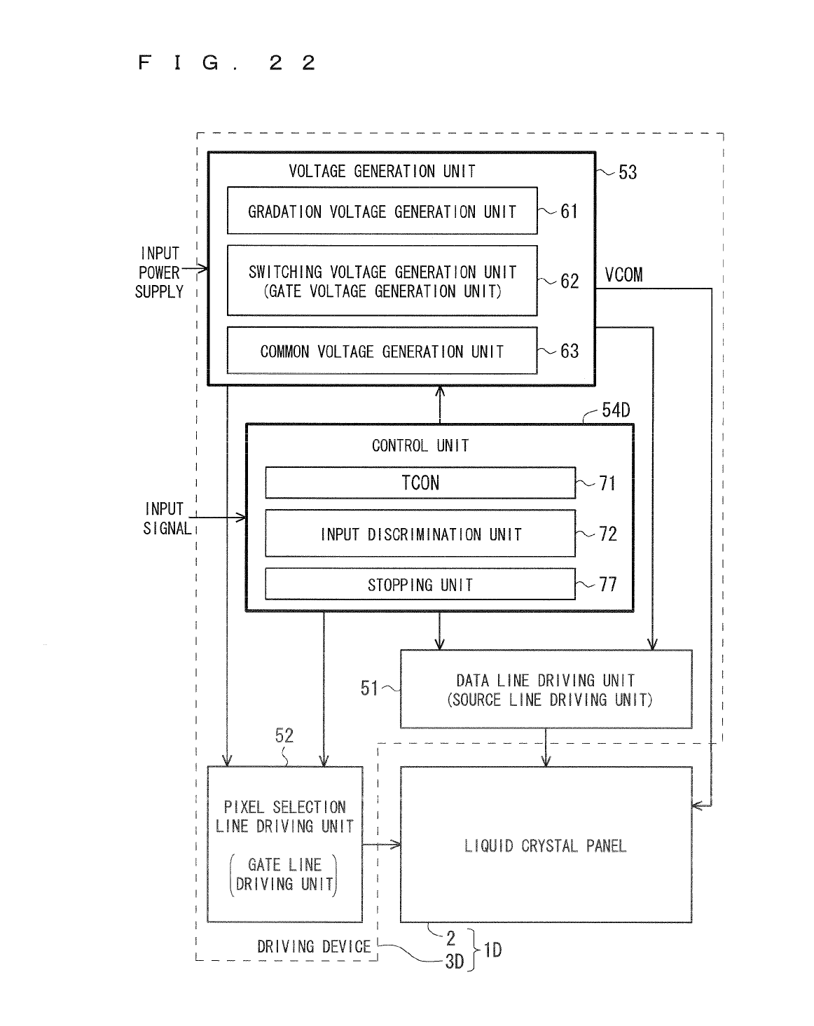

FIG. 22 is a block diagram showing a liquid crystal display 1D in accordance with the fourth preferred embodiment. The liquid crystal display 1D shown in FIG. 22 includes the same liquid crystal panel 2 as that in the first preferred embodiment and a driving device 3D for driving the liquid crystal panel 2. The driving device 3D has the same constitution as that of the driving device 3 in the first preferred embodiment, except that the driving device 3D includes a control unit 54D, instead of the control unit 54.

The control unit 54D includes the same TCON 71 and input discrimination unit 72 as those in the first preferred embodiment and also includes a stopping unit 77. The stopping unit 77 stops the operation of the voltage generation unit 53 when the discrimination result of the input discrimination unit 72 indicates the non-input state. The stopping unit 77 can be implemented, for example, by using a switch unit capable of cutting off the power supply which is used for driving the voltage generation unit 53.

In the above-discussed configuration, in the non-input state, no voltage is applied to all the pixel electrodes 34 and the common electrode 35. Therefore, like in the first preferred embodiment, it is possible to prevent the DC bias from being applied to the liquid crystal layer in the non-input state, and as a result, it is possible to prevent any problem in display such as image persistence, flicker, or the like.

Particularly in the fourth preferred embodiment, it is not necessary to control the potentials of the pixel electrode 34 and the common electrode 35. For this reason, it is possible to simplify the constitution and reduce the cost.

### The Fifth Preferred Embodiment

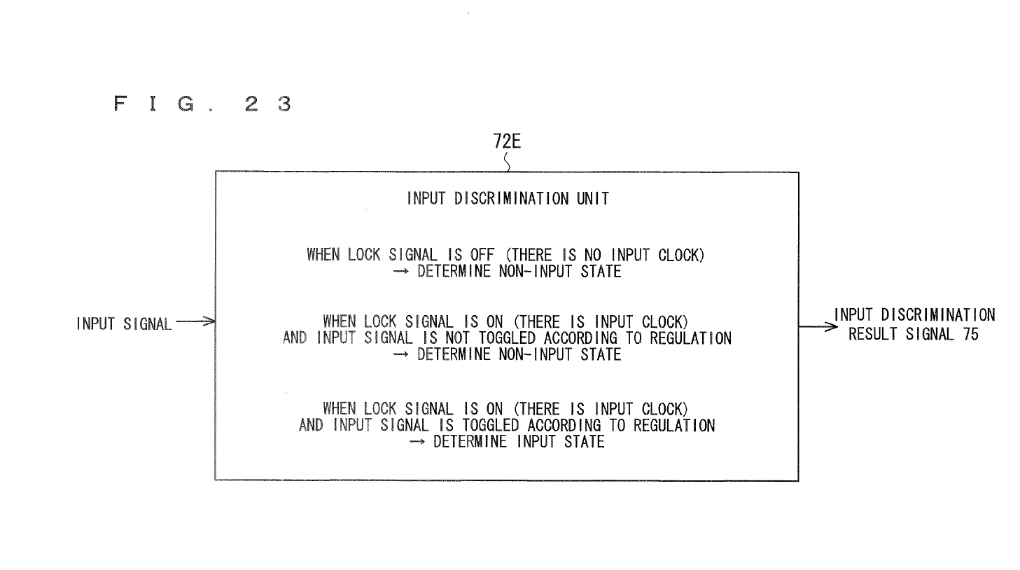

FIG. 23 illustrates a logical structure of an input discrimination unit 72E in accordance with the fifth preferred embodiment of the present invention. The input discrimination unit 72E, instead of the input discrimination unit 72 discussed earlier, is adopted in the liquid crystal displays 1 and 1D (see FIGS. 1 and 22). Further, the input discrimination unit 72E may be integrated with the TCON 71 as an IC.

In the exemplary structure of FIG. 23, the input discrimination unit 72E discriminates whether the input signal includes a predetermined clock or not, like the input discrimination unit 72 discussed earlier. For example, when a condition (synchronization condition) that synchronization with the input signal is established is satisfied, and more specifically when the DLL, the PLL, and the like output the LOCK_ON signal, the input discrimination unit 72E determines that it is in a state where there is an input clock.

When the input discrimination unit 72E determines that it is in a state where there is no input clock, the input discrimination unit 72E determines that the liquid crystal display 1 and 1D is in the non-input state, like in the first preferred embodiment, and outputs the input discrimination result signal 75 indicating the non-input state.

On the other hand, when the input discrimination unit 72E determines that it is in the state where there is an input clock, the input discrimination unit 72E of the fifth preferred embodiment discriminates whether a condition (validity condition) that the input signal includes valid display data is satisfied or not. For example, when the input signal does not appropriately include a timing control signal, such as the vertical synchronizing signal, the horizontal synchronizing signal, the data enable signal, or the like, it is determined that the input signal does not include any valid display data.

Further, the discrimination on whether the input signal appropriately includes the predetermined timing control signal or not can be performed by discriminating whether the input signal is toggled according to a regulation or not. For example, when the input signal is not toggled in excess of a regulation time or it is judged from the state of the data enable signal that there is an active period and/or an inactive period exceeding the regulation time in the input signal, the input discrimination unit 72E determines that the liquid crystal display 1 and 1D is in the non-input state and outputs the input discrimination result signal 75 indicating the non-input state. On the other hand, when the input signal is toggled according to the regulation, the input discrimination unit 72E determines that the liquid crystal display 1 and 1D is in the input state and outputs the input discrimination result signal 75 indicating the input state.

Also with the input discrimination unit 72E, the same effects as those in the first to fourth preferred embodiments can be produced. Particularly, with the input discrimination unit 72E, it is possible to discriminate a state where there is a clock but no display data from other states, and as a result, it is possible to discriminate between the input state and the non-input state with high accuracy.

### The Sixth Preferred Embodiment

Though the case has been discussed above where the gate line driving unit 52 has the ALL_ON function, a preferred configuration used in a case where the gate line driving unit 52 does not have the ALL_ON function will be discussed in the sixth preferred embodiment.

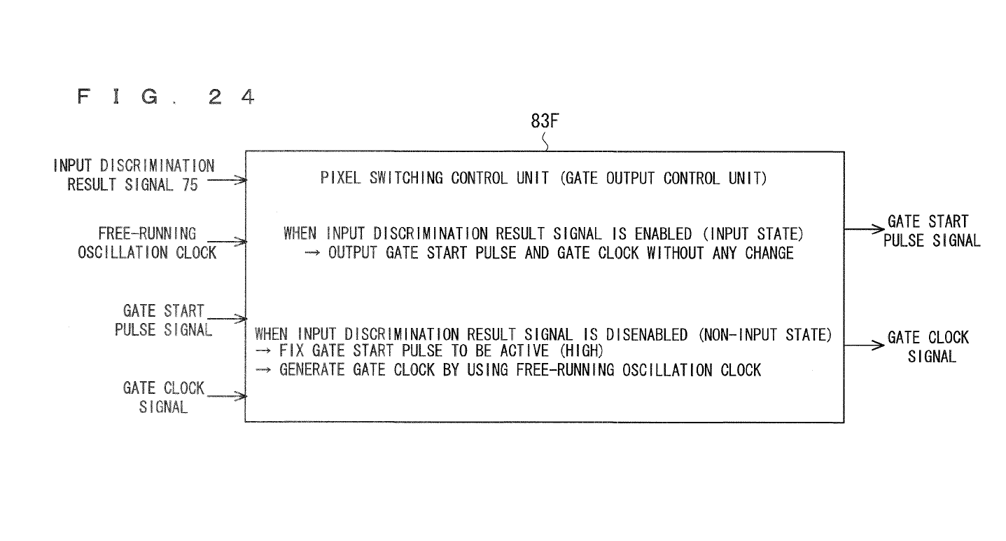

FIG. 24 is a view showing a pixel switching control unit 83F (hereinafter, referred to also as a “gate output control unit 83F”) in accordance with the sixth preferred embodiment. The gate output control unit 83F, instead of the gate output control unit 83 discussed earlier, is adopted in the liquid crystal display 1 (see FIG. 1). Further, the gate output control unit 83F may be integrated with the TCON 71 as an IC.

In the exemplary structure of FIG. 24, in the input state, the gate output control unit 83F supplies the gate line driving unit 52 with the gate start pulse signal and the gate clock signal outputted from the TCON 71, without any change.

On the other hand, in the non-input state, since the TCON 71 outputs neither the gate start pulse signal nor the gate clock signal, the gate output control unit 83F generates these signals and supplies these signals to the gate line driving unit 52. Specifically, the gate output control unit 83F generates the gate clock signal (in other words, the scan clock signal) by using a free-running oscillation clock outputted from a not-shown free-running oscillator circuit. The gate output control unit 83F also generates the gate start pulse signal fixed to be active. With this operation, the scan start instruction (corresponding to the active level of the gate start pulse signal) continues to be inputted to the gate line driving unit 52.

The gate start pulse signal is periodically set to be active, originally, so that after the scanning of all the gate lines 22 is finished, a next scanning should be started. In the non-input state, however, since the gate start pulse signal is fixed to be active as discussed above, the scanning of the gate lines 22 multiply occurs in accordance with the toggle of the gate clock signal. In other words, each of the gate lines 22 continues to be selected, and this makes an ALL_ON state of the gate lines 22.

Therefore, with the gate output control unit 83F, the same effects as those in the first, third, and fifth preferred embodiments can be produced even when the gate line driving unit 52 does not have the ALL_ON function.

### Variations

In the present invention, the preferred embodiments can be transformed or omitted as appropriate by free combination of the preferred embodiments within the scope of the invention.

While the invention has been shown and described in detail, the foregoing description is in all aspects illustrative and not restrictive. It is therefore understood that numerous modifications and variations can be devised without departing from the scope of the invention.

What is claimed is:

1. A liquid crystal display, comprising:
a liquid crystal panel including a plurality of pixel electrodes provided with respect to a plurality of pixels respectively, a common electrode for supplying said plurality of pixels with a common voltage, a plurality of data lines, a plurality of pixel selection lines, and a plurality of pixel switching units provided with respect to said plurality of pixels respectively, each of said plurality of said pixel switching units having one end connected to a corresponding pixel electrode, the other end connected to a predetermined data line, and a control end connected to a predetermined pixel selection line, for controlling conduction between said one end and said other end; and
a driving device for driving said liquid crystal panel,
wherein said driving device includes
a data line driving unit for driving said plurality of data lines;
a pixel selection line driving unit for driving said plurality of pixel selection lines to control said plurality of pixel switching units;
a voltage generation unit for generating various voltages used for said data line driving unit, said pixel selection line driving unit, and said common electrode; and
a control unit for controlling an operation of said driving device, and
said control unit has
an input discrimination unit for discriminating between an input state where a video signal is inputted and a non-input state where said video signal is not inputted; and
a regulation unit for regulating a potential difference between said pixel electrode and said common electrode to zero with respect to said plurality of pixels in said non-input state.

2. The liquid crystal display according to claim 1, wherein
said voltage generation unit has
a gradation voltage generation unit for generating a plurality of gradation voltages to be supplied to said pixel electrode and supplying said plurality of gradation voltages to said data line driving unit;
a switching voltage generation unit for generating a switching-ON voltage to bring said pixel switching unit into an ON state and a switching-OFF voltage to bring said pixel switching unit into an OFF state and supplying said switching-ON voltage and said switching-OFF voltage to said pixel selection line driving unit; and
a common voltage generation unit for generating said common voltage and supplying said common voltage to said common electrode, and
said regulation unit has
a gradation voltage regulation unit for changing all said plurality of gradation voltages outputted from said gradation voltage generation unit to a predetermined regulated potential in said non-input state;
a data output control unit for controlling said data line driving unit so that said predetermined regulated potential outputted from said gradation voltage generation unit is supplied to all said plurality of data lines in said non-input state;
a pixel switching control unit for preventing said pixel switching unit from being brought into said OFF state with respect to all said plurality of pixels in said non-input state; and
a common voltage regulation unit for changing said common voltage to said predetermined regulated potential in said non-input state.

3. The liquid crystal display according to claim 1, wherein
said voltage generation unit has
a gradation voltage generation unit for generating a plurality of gradation voltages to be supplied to said pixel electrode and supplying said plurality of gradation voltages to said data line driving unit;
a switching voltage generation unit for generating a switching-ON voltage to bring said pixel switching unit into an ON state and a switching-OFF voltage to bring said pixel switching unit into an OFF state and supplying said switching-ON voltage and said switching-OFF voltage to said pixel selection line driving unit; and
a common voltage generation unit for generating said common voltage and supplying said common voltage to said common electrode, and
said regulation unit has
a gradation voltage regulation unit for changing all said plurality of gradation voltages outputted from said gradation voltage generation unit to said common voltage in said non-input state; and
a pixel switching control unit for preventing said pixel switching unit from being brought into said OFF state with respect to all said plurality of pixels in said non-input state.

4. The liquid crystal display according to claim 2, wherein
said pixel switching control unit controls said pixel selection line driving unit so that said switching-ON voltage is supplied to all said plurality of pixel selection lines in said non-input state.

5. The liquid crystal display according to claim 3, wherein
said pixel switching control unit controls said pixel selection line driving unit so that said switching-ON voltage is supplied to all said plurality of pixel selection lines in said non-input state.

6. The liquid crystal display according to claim 4, wherein
said pixel selection line driving unit has an ALL_ON function for making it possible to output said switching-ON voltage simultaneously to all said plurality of pixel selection lines, and
said pixel switching control unit activates said ALL_ON function in said non-input state.

7. The liquid crystal display according to claim 5, wherein
said pixel selection line driving unit has an ALL_ON function for making it possible to output said switching-ON voltage simultaneously to all said plurality of pixel selection lines, and
said pixel switching control unit activates said ALL_ON function in said non-input state.

8. The liquid crystal display according to claim 4, wherein
said pixel selection line driving unit has a scan function for supplying a first pixel selection line set in advance with said switching-ON voltage in response to a scan start instruction and sequentially changing a pixel selection line to be supplied with said switching-ON voltage in accordance with a scan clock signal, and
said pixel switching control unit, in said non-input state, inputs said scan clock signal to said pixel selection line driving unit and continues to give said scan start instruction to said pixel selection line driving unit.

9. The liquid crystal display according to claim 5, wherein
said pixel selection line driving unit has a scan function for supplying a first pixel selection line set in advance with said switching-ON voltage in response to a scan start instruction and sequentially changing a pixel selection line to be supplied with said switching-ON voltage in accordance with a scan clock signal, and
said pixel switching control unit, in said non-input state, inputs said scan clock signal to said pixel selection line driving unit and continues to give said scan start instruction to said pixel selection line driving unit.

10. The liquid crystal display according to claim 2, wherein
said pixel switching control unit changes said switching-OFF voltage to a potential with which said pixel switching unit is not brought into said OFF state in said non-input state.

11. The liquid crystal display according to claim 3, wherein
said pixel switching control unit changes said switching-OFF voltage to a potential with which said pixel switching unit is not brought into said OFF state in said non-input state.

12. The liquid crystal display according to claim 2, wherein
said gradation voltage generation unit and said common voltage generation unit are provided between a high power supply potential and a low power supply potential, and
said predetermined regulated potential is said low power supply potential.

13. The liquid crystal display according to claim 1, wherein
said input discrimination unit determines that the liquid crystal display is in said input state when a synchronization condition that synchronization with an input signal inputted to an input unit for said video signal is established is satisfied.

14. The liquid crystal display according to claim 1, wherein
said input discrimination unit determines that the liquid crystal display is in said input state when a synchronization condition that synchronization with an input signal inputted to an input unit for said video signal is established and a validity condition that said input signal includes valid display data are satisfied.

15. A liquid crystal display, comprising:
a liquid crystal panel including a plurality of pixel electrodes provided with respect to a plurality of pixels respectively, a common electrode for supplying said plurality of pixels with a common voltage, a plurality of data lines, a plurality of pixel selection lines, and a plurality of pixel switching units provided with respect to said plurality of pixels respectively, each of said plurality of said pixel switching units having one end connected to a corresponding pixel electrode, the other end connected to a predetermined data line, and a control end connected to a predetermined pixel selection line, for controlling conduction between said one end and said other end; and
a driving device for driving said liquid crystal panel,
wherein said driving device includes
a data line driving unit for driving said plurality of data lines;
a pixel selection line driving unit for driving said plurality of pixel selection lines to control said plurality of pixel switching units;
a voltage generation unit for generating various voltages used for said data line driving unit, said pixel selection line driving unit, and said common electrode; and
a control unit for controlling an operation of said driving device, and
said control unit has
an input discrimination unit for discriminating between an input state where a video signal is inputted and a non-input state where said video signal is not inputted; and
a stopping unit for stopping an operation of said voltage generation unit in said non-input state.

16. The liquid crystal display according to claim 15, wherein
said input discrimination unit determines that the liquid crystal display is in said input state when a synchronization condition that synchronization with an input signal inputted to an input unit for said video signal is established is satisfied.

17. The liquid crystal display according to claim 15, wherein
said input discrimination unit determines that the liquid crystal display is in said input state when a synchronization condition that synchronization with an input signal inputted to an input unit for said video signal is established and a validity condition that said input signal includes valid display data are satisfied.
